(19) United States
(12) Patent Application Publication
(10) Pub. No.: US 2011/0285548 A1
(43) Pub. Date: Nov. 24, 2011

(54) Traffic sign

(76) Inventor: Tony Chi-Tien Liu, Taichung (TW)

(21) Appl. No.: 13/014,727

(22) Filed: Jan. 27, 2011

(30) Foreign Application Priority Data
May 24, 2010 (CN) 201020200636.8

(51) Int. Cl. G08G 1/095; G09F 13/16; G08G 1/00; G09F 7/00

(52) U.S. Cl. 340/907; 40/612; 40/582

(57) ABSTRACT

A traffic sign includes a post; a base plate mounted on the post; at least one panel formed on the base plate, at least one panel formed on the base plate, each of the at least one panel being red, yellow, green, or blue; and at least one letter each formed on the panel, each of the at least one letter being “E” indicating east, “W” indicating west, “S” indicating south, or “N” indicating north. The traffic sign has colors of the panels chosen by considering common sense into consideration. A motorist may see the color of each panel of a traffic sign well ahead of the automobile driving on a highway. This is because the eyes are more sensitive to colors. A motorist can easily decide when to leave the highway when seeing the color of the panel with the further indication of the direction letter therein.

### BACKGROUND OF THE INVENTION

1. Field of Invention

The invention relates to traffic signs and more particularly to a traffic sign having at least one of red, green, yellow, and blue panels of stylized cross, the red, green, yellow, and blue panels of stylized cross being for indicating east, south, west, and north respectively.

2. Description of Related Art

Traffic signs are signs erected at the side of roads to provide information to road users. With traffic volumes increasing greatly, many countries have adopted pictorial signs or the like and standardized their signs to help enhance traffic safety. Such pictorial signs use symbols in place of words and are usually based on international protocols.

Distances from the places and directions are typically printed on a traffic sign as information for motorists when riding on a highway. For a motorist, especially one not familiar with the place to be visited, direction signs are the most important for deciding which exit should the motorist leave the highway.

A typical traffic sign is shown in FIG. 1 and comprises a rectangular base plate 1 mounted laterally on a post, and two upper and two lower characters 2 printed or otherwise formed on the base plate 1.

Another typical traffic sign is shown in FIG. 2 and comprises a rectangular base plate 3 mounted on a top end of a post, and a character 4 printed or otherwise formed on the base plate 3.

It is understood that an automobile may drive at a high speed on a highway. Motorists, especially those having poor vision and foreigners, may have difficulty of comprehending meanings of such abbreviations (e.g., “S” means south, “N” means north, etc.) on the typical traffic signs instantly when viewing it. It is often that a motorist may miss the sign. Thereafter, the motorist may change lane suddenly to try to leave the highway at the exit being approached. Unfortunately, it often may cause car crash. This is not desired. Thus, the need for improvement still exists.

### SUMMARY OF THE INVENTION

It is therefore one object of the invention to provide a traffic sign having colors of panels chosen by considering the common sense into consideration. Thus, motorists can easily decide when to leave the highway when viewing both the direction letter (e.g., “E”, “W”, “N”, or “S”) in the panel and the color (e.g., red, yellow, blue, or green) of the panel.

To achieve the above and other objects, the invention provides a traffic sign comprising a post; a base plate mounted on the post; at least one panel formed on the base plate, each of the at least one panel being red, yellow, green, or blue; and at least one letter each formed on the panel, each of the at least one letter being “E” indicating east, “W” indicating west, “S” indicating south, or “N” indicating north.

In one aspect of the invention the panels are stylized crosses each having four equal triangular arms at right angles, each arm with a sharp outer end.

In another aspect of the invention each of the at least one panel is formed of a plurality of red, yellow, green, or blue LEDs (light-emitting diodes).

In a further aspect of the invention each of the at least one panel is formed of red, yellow, green, or blue light reflective coating.

The above and other objects, features and advantages of the invention will become apparent from the following detailed description taken with the accompanying drawings.

### BRIEF DESCRIPTION OF THE DRAWINGS

FIG. 1 is a front view of a typical traffic sign;

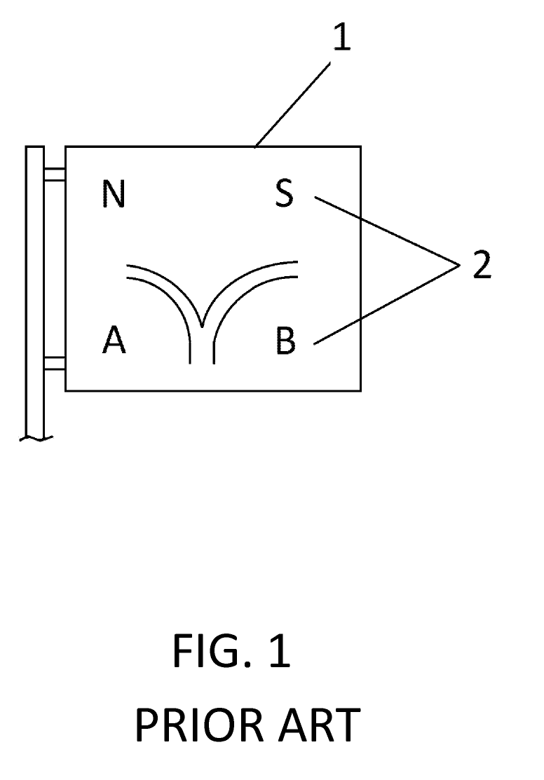

FIG. 2 is a front view of another typical traffic sign;

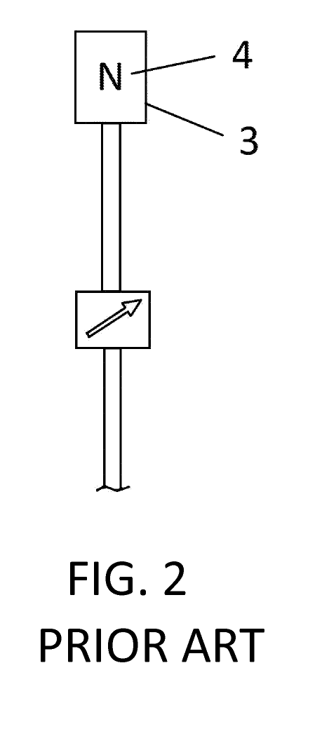

FIGS. 3A, 3B, 3C, and 3D are front views of panels with “E”, “W”, “S”, and “N” letters printed on a traffic sign according to the invention respectively;

FIG. 4 is a front view of a traffic sign according to the invention with “W” printed on center of a stylized cross yellow panel and “E” printed on center of a stylized cross red panel;

FIG. 5 is a front view of another traffic sign according to the invention with “N” printed on center of a stylized cross blue panel on an upper portion; and

FIG. 6 is a front view of a further traffic sign according to the invention with “N” printed on center of a stylized cross blue panel and “S” printed on center of a stylized cross green panel.

### DETAILED DESCRIPTION OF THE INVENTION

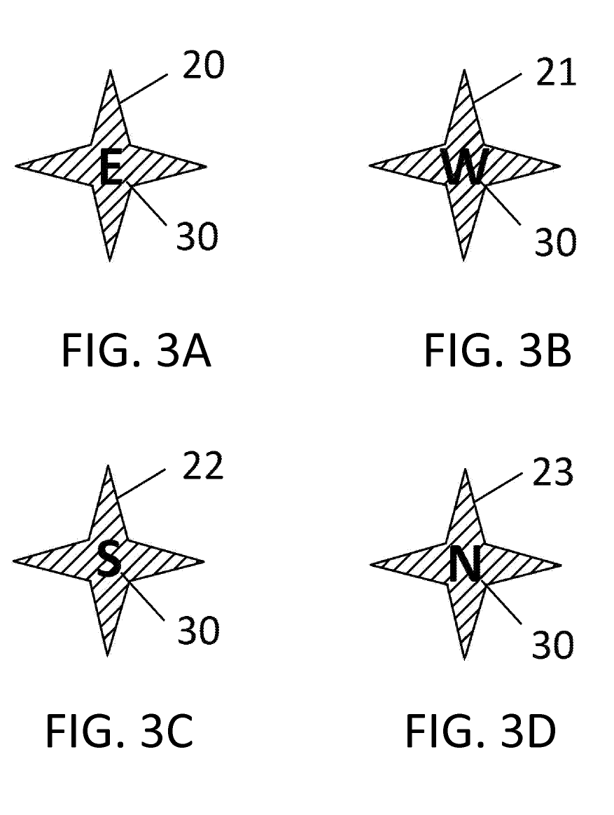

Referring to FIG. 3A, a panel 20 is printed on a traffic sign according to the invention. The panel 20 is shaped as a stylized cross having four equal triangular arms at right angles, each arm with a sharp outer end. The panel 20 is red for representing sunrise. A letter (e.g., “E” as abbreviation of east) 30 is printed on a center of the panel 20. That is, the sun rises from the east.

Referring to FIG. 3B, a panel 21 is printed on a traffic sign according to the invention. The panel 21 is shaped as a stylized cross having four equal triangular arms at right angles, each arm with a sharp outer end. The panel 21 is yellow for representing sunset. A letter (e.g., “W” as abbreviation of west) 30 is printed on a center of the panel 21. That is, the sun sets in the east.

Referring to FIG. 3C, a panel 22 is printed on a traffic sign according to the invention. The panel 22 is shaped as a stylized cross having four equal triangular arms at right angles, each arm with a sharp outer end. The panel 22 is green for representing green grass. A letter (e.g., “S” as abbreviation of south) 30 is printed on a center of the panel 22. That is, a person can see green grass representing south when lowering the head.

Referring to FIG. 3D, a panel 23 is printed on a traffic sign according to the invention. The panel 23 is shaped as a stylized cross having four equal triangular arms at right angles, each arm with a sharp outer end. The panel 23 is blue for representing blue sky. A letter (e.g., “N” as abbreviation of north) 30 is printed on a center of the panel 23. That is, a person can see blue sky representing north when lifting the head.

Preferably, the panels 20, 21, 22 and 23 are formed of a plurality of red, yellow, green and blue LEDs (light-emitting diodes) respectively. The LEDs are powered either by solar panels or by electricity supplied from other electric sources along a highway.

Alternatively, the panels 20, 21, 22 and 23 are red, yellow, green and blue light reflective coatings respectively.

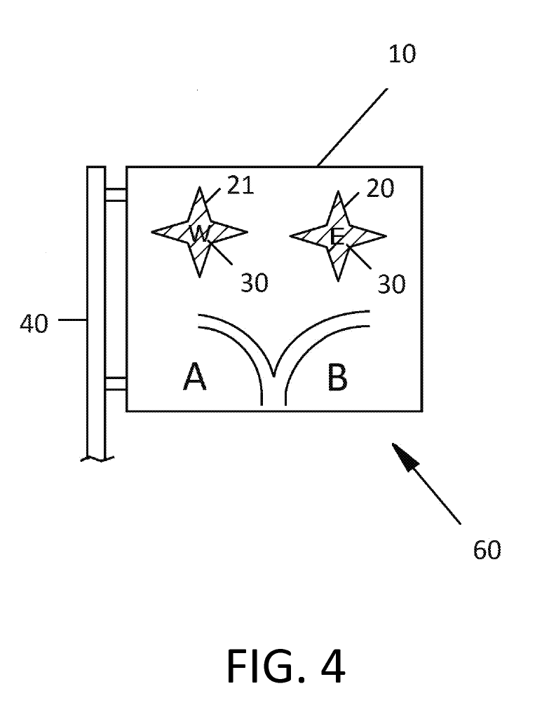

Referring to FIG. 4, a first embodiment of traffic sign 60 of the invention is shown. The traffic sign 60 comprises a post 40 and a rectangular base plate 10 secured laterally to the post 40. The top left panel is implemented as a stylized cross yellow panel 21 with letter “W” 30 formed on center, letter “A” under the panel 21 representing Santa Barbara, Calif., the top right panel is implemented as a stylized cross red panel 20 with letter “E” 30 formed on center, and letter “B” under the panel 20 representing Riverside, Calif. respectively.

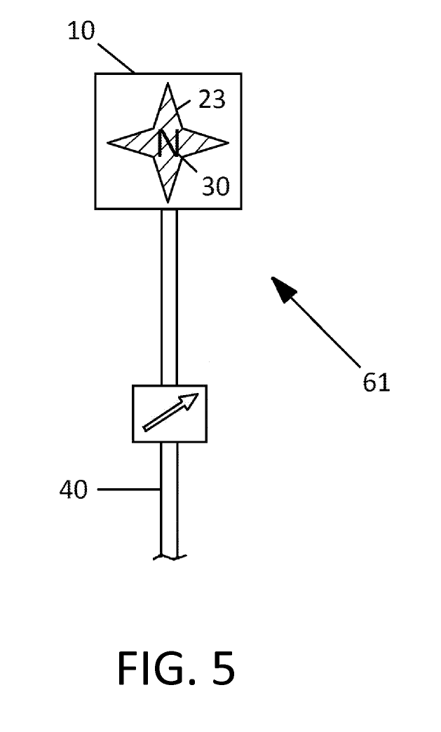

Referring to FIG. 5, a second embodiment of traffic sign 61 of the invention is shown. The traffic sign 61 comprises a post 40 and a rectangular base plate 10 secured to top end of the post 40. The panel is implemented as a stylized cross blue panel 23 and letter “N” 30 formed on center.

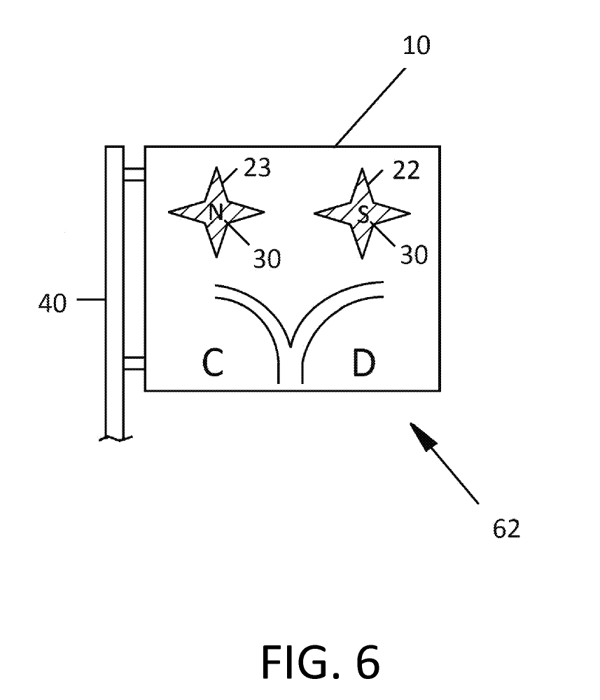

Referring to FIG. 6, a third embodiment of traffic sign 62 of the invention is shown. The traffic sign 62 comprises a post 40 and a rectangular base plate 10 secured laterally to the post 40. The top left panel is implemented as a stylized cross blue panel 23 with letter “N” 30 formed on center, letter “C” under the panel 23 representing Alhambra, Calif., the top right panel is implemented as a stylized cross green panel 22 with letter “S” 30 formed on center, and letter “D” under the panel 22 representing Rosemead, Calif. respectively.

In brief, the colors of the panels are chosen by considering the common sense into consideration. A motorist may see the color of each panel of a traffic sign well ahead of his or her automobile driving on a highway. This is because the eyes are more sensitive to colors than characters or letters. Hence, a motorist can easily decide when to leave the highway when seeing the color (e.g., red, yellow, blue, or green) of the panel with the further indication of the direction letter (e.g., “E”, “W”, “N”, or “S”) therein. The invention has the advantages of helping motorists find the destination without getting lost and thus greatly decreasing the probability of car crash.

While the invention has been described in terms of preferred embodiments, those skilled in the art will recognize that the invention can be practiced with modifications within the spirit and scope of the appended claims.

What is claimed is:

1. A traffic sign comprising:
a post;
a base plate mounted on the post;
at least one panel formed on the base plate, each of the at least one panel being red, yellow, green, or blue; and
at least one letter each formed on the panel, each of the at least one letter being “E” indicating east, “W” indicating west, “S” indicating south, or “N” indicating north.

2. The traffic sign of claim 1, wherein each of the at least one panel is a stylized cross having four equal triangular arms at right angles, each arm with a sharp outer end.

3. The traffic sign of claim 1, wherein each of the at least one panel is formed of a plurality of red, yellow, green, or blue LEDs (light-emitting diodes).

4. The traffic sign of claim 1, wherein each of the at least one panel is a red, yellow, green, or blue light reflective coating.
